(19) United States
(12) Patent Application Publication
(10) Pub. No.: US 2016/0265563 A1
(43) Pub. Date: Sep. 15, 2016

(54) Linear Drive and Method for its Manufacture

(71) Applicant: FESTO AG & CO. KG, Esslingen (DE)

(72) Inventors: Eric Angué, Kornwestheim (DE); Simone Kopp, Esslingen (DE); Ulrich Diener, Esslingen (DE)

(21) Appl. No.: 14/401,759

(22) PCT Filed: Dec. 24, 2013
(86) PCT No.: PCT/EP2013/003942

§ 371 Date: Nov. 17, 2014

(51) Int. Cl. F15B 15/14; F16H 19/06; H02K 7/06

(52) U.S. Cl. CPC F15B 15/1471; H02K 7/06; F16H 19/06; F16H 2019/0681

(57) ABSTRACT

A linear drive, with a drive unit containing a drive housing with a single-piece guide body, wherein guide tracks are formed on the guide body for the linear guidance of an output slide. The guide body is made in one piece as a bent sheet metal part and has several leg sections bent relative to one another at bending areas, wherein two of these leg sections bent relative to one another at bending areas, wherein two of these leg sections lie opposite one another and form guide legs which have the guide tracks. A method for the manufacture of such a linear drive.

The invention relates to a linear drive with a drive unit which has a drive housing with a longitudinal axis, also with an output slide which is linear movably guided on the drive housing to execute a stroke movement oriented in the axial direction of the longitudinal axis, and with drive means to generate the stroke movement of the output slide, wherein the drive housing has a single-piece guide body, on which are formed several guide tracks, extending in the axial direction of the longitudinal axis and spaced apart transversely to the longitudinal axis, and on which the output slide is movably and linearly guided to execute the stroke movement.

The invention also relates to a method for the manufacture of such a linear drive.

A linear drive of this kind known from DE 33 30 933 A1 has a drive unit and an output slide, wherein the output slide is mounted with the facility for linear movement on a single-piece guide body belonging to a drive housing of the drive unit. The output slide may be driven by means of the drive unit to make a linear stroke movement along the single-piece guide body, wherein it receives the actuating power required to execute the stroke movement from a piston rod extending out from the drive housing and belonging to drive means of the drive unit. The guide body is a block-shaped component, the external shaping of which may be produced by machining, wherein longitudinal grooves inserted in the outer surface of the guide body define guide tracks serving for linear guidance of the output slide. Manufacture of the known linear drive is likely to be laborious and, owing to the large amount of material needed, also relatively expensive. The known linear drive will also probably be relative heavy, which is a disadvantage especially when it is intended for integration in a moved system.

Known from DE 10 2011 016 282 A1 is a linear drive which has a block-shaped drive housing forming a single-piece guide body on which is mounted with linear movement capability an output slide, with the interposition of a separate linear drive device. The output slide has a multi-part structure and a slide table with a single-piece guide section made by pressing. Press moulding of the guide section enables the production costs of this linear drive to be reduced. Equally, manufacture of the drive housing, which is presumably made by extrusion and/or machining, is relatively time-consuming and expensive.

The invention is based on the problem of taking measures which make possible especially easy and cost-effective manufacture of a linear drive.

To solve this problem it is provided according to the invention, for a linear drive of the type described above, that the single-piece guide body is a bent sheet metal part with several leg sections which are bent relative to one another in bending areas extending parallel to the longitudinal axis, wherein at least two of these leg sections lie opposite with clearance transversely to the longitudinal axis, in each case forming a guide leg which has at least one of the guide tracks.

The problem is also solved, in connection with the method features of the type described above, by providing that the single-piece guide body is made by bend forming as a bent sheet metal part on the basis of a plate-shaped unworked sheet metal part, suitably contoured beforehand at the edges, with the unworked sheet metal part being bent to form several leg sections of the guide body at several bending areas extending parallel to the longitudinal axis in such a way that at least two of these bent leg sections lie opposite with clearance transversely to the longitudinal axis, and in each case form a guide leg assigned at least one of the guide tracks.

The design of the guide body as a single-piece bent sheet metal part opens up the possibility of technically simple and cost-effective manufacture of the drive housing. In the manufacture of the guide body, on the one hand laborious machining processes are not required, and moreover there are not inconsiderable savings in material in comparison with conventional designs. During the forming by bending, guide legs equipped with guide tracks may be produced by simple bending processes in which the bent sheet metal part is bent in bending areas extending parallel to the longitudinal axis wherein, of the resulting leg sections of the bent sheet metal part, two opposite leg sections may be used as guide legs provided with guide tracks. To manufacture the guide body, use is made preferably of a plate-shaped unworked sheet metal part, the outer contour of which is designed to take into account the desired final shape of the guide body, and is in particular suitably cut to size—for example by laser cutting or by stamping—and which is then so reshaped or bent using suitable bending tools, for example bending rollers, that the guide body is produced with the final shape with the two guide legs with the guide tracks. Especially advantageous in connection with the design and method of manufacture according to the invention is the variability in the possible shape of the guide body which makes it possible to obtain, in a cost-effective manner, individually shaped guide bodies, and in particular taking into consideration the nature of the drive means to be used.

Advantageous developments of the invention are disclosed in the dependent claims.

The guide tracks used for the linear guidance of the output slide are formed preferably by groove-like recesses of the guide legs. These may be for example impressed before bend forming in the sections of the unworked sheet metal part forming the guide legs. It is however regarded as especially advantageous if the guide tracks are formed by profiled bent structures of the guide legs, i.e. the two guide legs are essentially bent directly in such a way that they have the cross-sectional contour forming the respectively assigned guide track or tracks. At the same time the guide legs are bent in particular into trough-shaped bent structural sections, resulting in groove-like recesses, the boundary surfaces of which may be used as guide tracks.

If the guide tracks are produced directly in the form of profiled bent structural sections by the bending of the bent sheet metal part, this gives the benefit of avoiding the need for different production technologies, thereby allowing a further reduction in costs.

The guide tracks are formed preferably on facing inner sides of the opposing guide legs. This makes it possible to obtain a compact linear drive in which the output slide dips between the guide legs. Similarly possible, though, is a design in which the guide tracks are provided on the outer sides of the guide legs facing away from one another, wherein they are expediently encompassed by the guide slides.

Each guide leg is expediently a single-piece component of a guide body section with a substantially L-shaped profile. It is also possible to have a design in which one leg section of the bent sheet metal part is simultaneously part of two guide body sections with L-shaped profiles.

Regarded as especially expedient is a design in which each guide leg is a single-piece component of a guide body section with a profile which is at least substantially U-shaped. In the simplest case, the guide body is formed solely by a guide body section with a substantially U-shaped profile.

The guide body is preferably made from a steel sheet. Exceptional resistance to corrosion may be obtained if stainless steel sheet is used.

Expediently, at least one guide element supporting the output slide relative to the drive housing, transversely to the longitudinal axis, is in contact with the guide tracks of the guide body. Preferably each guide track has several guide elements, arranged consecutively in the axial direction of the longitudinal axis. If the guide tracks are parts of groove-like recesses, in particular formed by trough-shaped bent sections of the guide body, then the guide elements engage in these guide grooves and are in this way exactly centred.

The guide elements are in particular roller elements, for example in the form of balls, rollers or needles. In this connection it is possible for example to use a cage principle in which several roller elements per guide track are combined by means of a cage element to form a roller element assembly, which moves along the guide tracks during the stroke movement of the output slide. Also advantageously possible is an embodiment based on the so-called circulatory principle, in which use is made in particular of recirculating ball bearings, involving spherical roller elements circulating during the linear movement of the output slide in a self-contained guide channel which is bounded in part by the guide tracks of the guide body.

On account of the forming by bending, the guide body generally has a contour which defines one or more internal spaces passing axially through it. This internal space or these internal spaces may be channel-like in form, and open at one point over their entire length. If the guide body has a U-shaped cross-sectional profile, it defines a single internal space, bounded at the sides by the guide legs with the guide tracks. It is advantageous for the drive housing to have at least one sealing body, attached or attachable to an end face of the guide body in order to seal off at the end, wholly or partly, each internal space defined by the guide body.

In an advantageous design, the drive means responsible for the generation of the stroke movement are mounted in at least one internal space defined by the single-piece guide body. It is even possible to have a design in which the drive means in their entirety are accommodated in at least one internal space of the guide body.

Expediently the single-piece guide body is so bent around the bending areas extending parallel to the longitudinal axis of the guide body that it defines a central internal space extending directly between the guide legs. This internal space may be open on one long side, with the output slide with its linear movement capability being located in the area of this open long side. Expediently the drive means are accommodated at least partly in the central internal space.

A further possible embodiment provides that the single-piece guide body is so bent that it defines, in addition to a central internal space, at least one outer internal space flanking the central internal space on its long side. This outer internal space may be separated at least partially from the central internal space by at least one or also several leg sections of the guide body. Regarded as especially expedient is an embodiment in which the guide body is bent in such a way that two outer internal spaces are created, flanking the central internal space on opposite long sides, and each separated by at least one leg section from the internal space situated between them.

The drive means provided to drive the output slide may be located at least partly in the outer internal space or spaces. If the drive means include a circulating drive train, for example a toothed belt, then two outer internal spaces flanking the central internal space may be used, so that each may accommodate one of two train strands of the drive train extending in parallel. In this case it is provided in particular that a drive motor is mounted on or in a end body attached to the end face of the guide body.

There is however in particular also the possibility of using each of the two outer internal spaces to accommodate a fluid-actuated actuator, for example a pneumatic cylinder. If the guide body defines only a single central internal space, this central internal space may be used for example to accommodate a fluid-actuated actuator or also components of an electrical drive system, for example a rotatably mounted drive spindle.

The linear drive is suitable for equipping with any desired type of drive means. It is preferably equipped with electrical and/or fluid-actuated drive means. The nature of the drive means is geared in particular to the intended application of the linear drive.

The invention is explained in detail below with the aid of the appended drawing, which shows in:

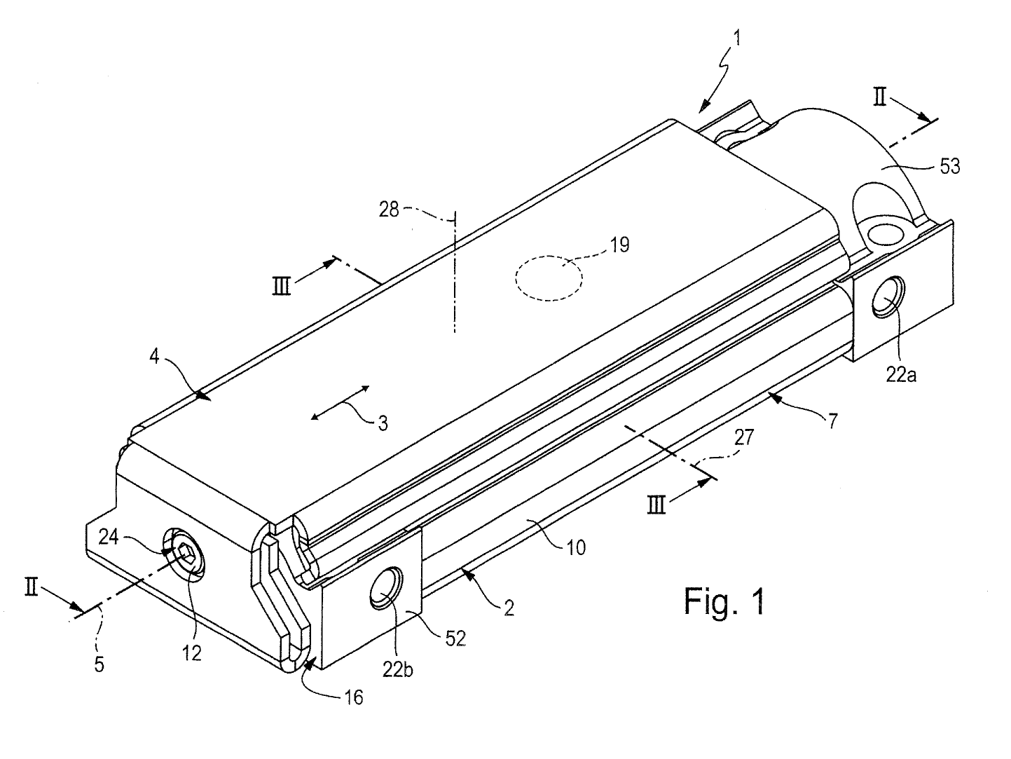

FIG. 1 a preferred first embodiment of the linear drive according to the invention in an isometric view

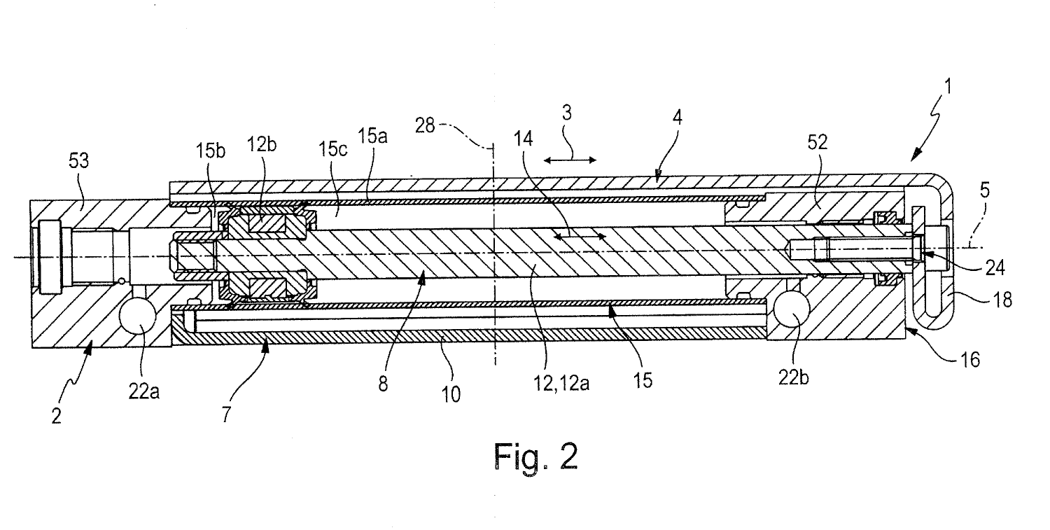

FIG. 2 a longitudinal section of the linear drive of FIG. 1 along section line II-II

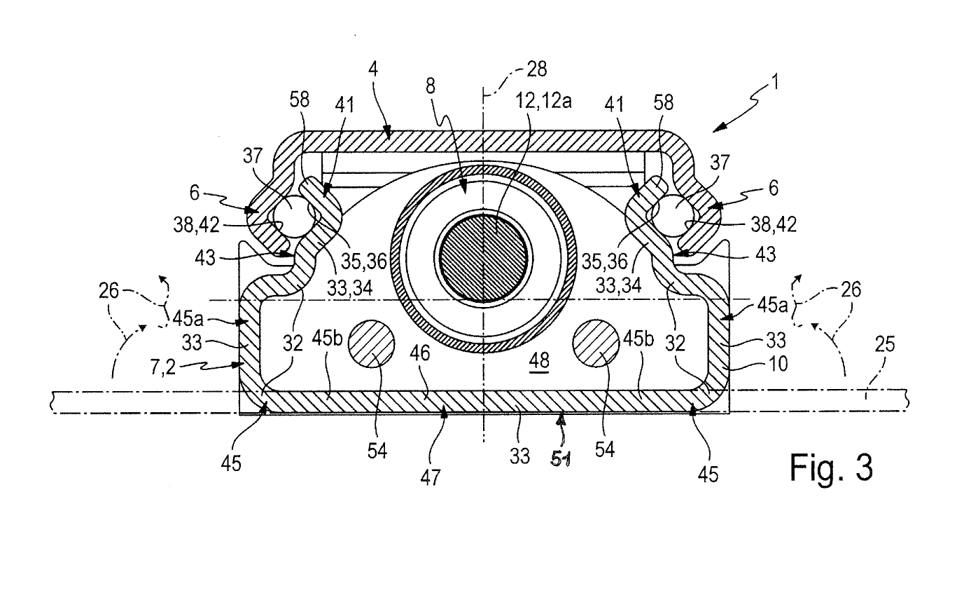

FIG. 3 a cross-section of the linear drive of FIGS. 1 and 2 according to section line of FIG. 1, wherein dot-dash lines indicate the contour of an unworked sheet metal part subject to forming by bending, and dot-dash arrows indicate schematically the bending process performed to create the guide body

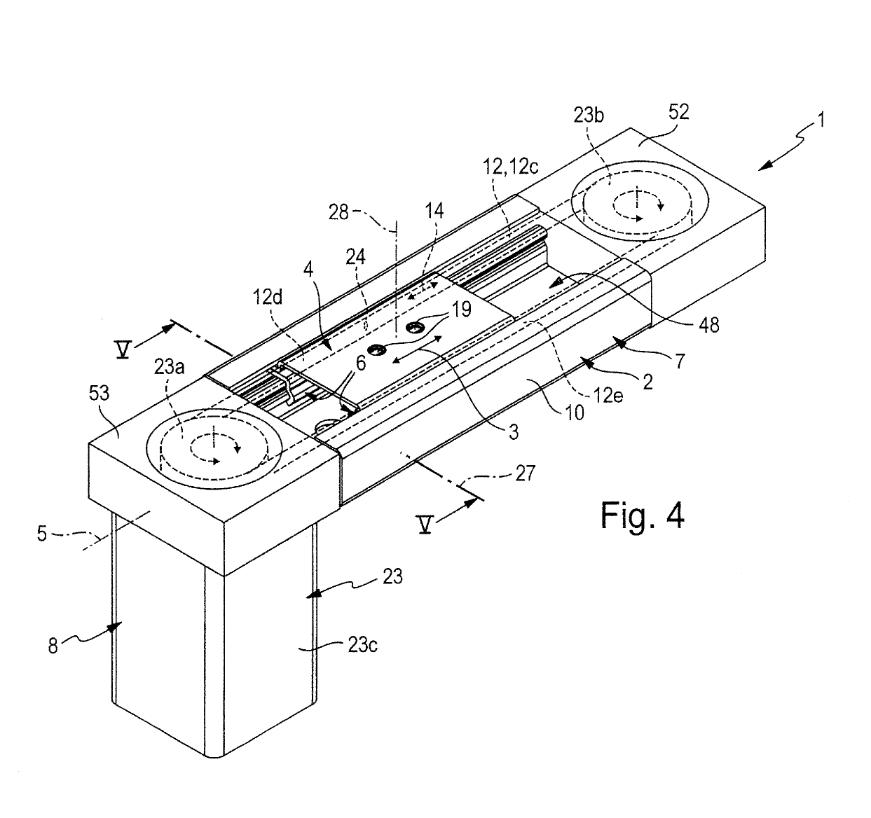

FIG. 4 another preferred embodiment of the linear drive according to the invention in an isometric view

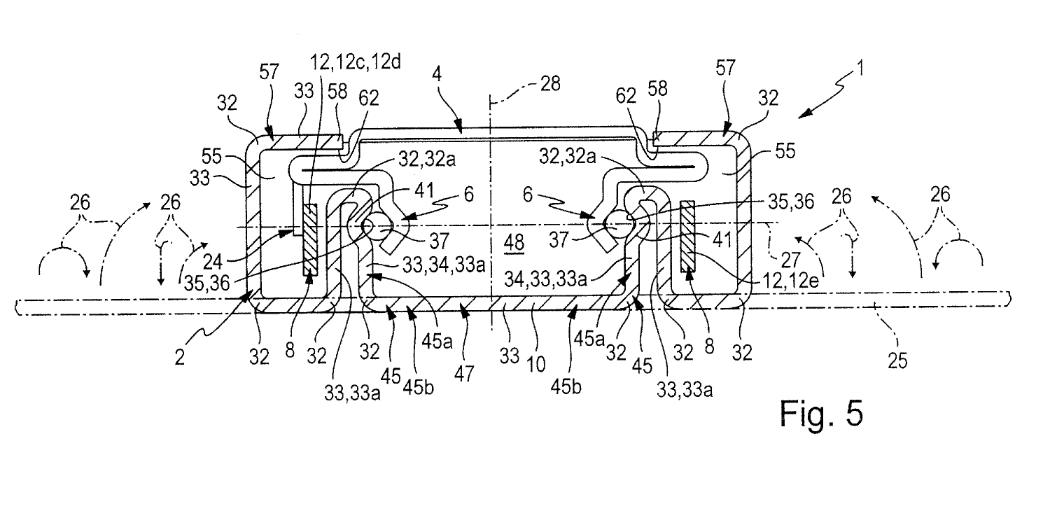

FIG. 5 a cross-section of the linear drive of FIG. 4 in the area of the guide body according to section line V-V of FIG. 4, and

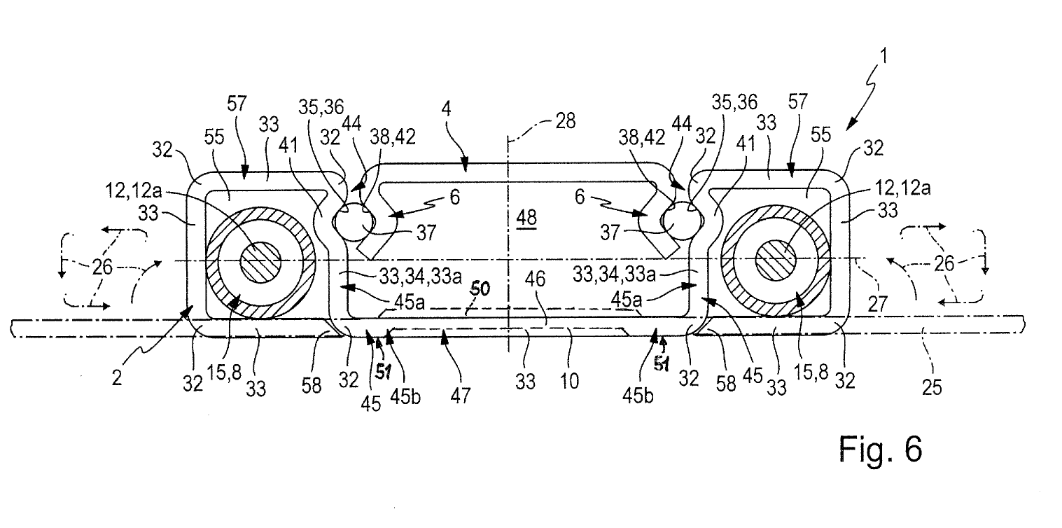

FIG. 6 an end view of a further embodiment of the linear drive according to the invention, omitting any end body attached to the end face.

In FIGS. 5 and 6, as in FIG. 3, dot-dash lines indicate the external contour of an unworked sheet metal part 25 subject to forming by bending, and dot-dash arrows 26 illustrate schematically the bend forming process.

The drawing shows several embodiments of a linear drive designated altogether by reference number 1, which has a drive unit 2 with a drive housing 7, and an output slide 4 mounted with linear movement facility relative to the drive housing 7 to execute a linear stroke movement 3 illustrated by a double arrow.

The linear drive 1 has a longitudinal axis 5, which also forms the longitudinal axis of the drive unit 2, the drive housing 7 and the output slide 4. The stroke movement 3 runs in the axial direction of this longitudinal axis 5. The output slide 4 is here able to move in opposite directions relative to the drive housing 7.

On the long side the output slide 4 is mounted adjacent to the drive housing 7. It may lie completely outside the drive housing 7, as is the case in the embodiment of FIGS. 1 to 3, but may also be mounted completely or partly recessed in the drive housing 7, as shown by way of example in FIGS. 4 to 6.

Linear guidance means, altogether designated by reference number 6, ensure that the output slide 4 is supported relative to the drive housing 7 at right-angles to the longitudinal axis 5 and has linear guidance to execute the stroke movement 3. The components of the linear guidance means 6 belonging to the drive housing 7 are formed, in particular solely, on a single-piece guide body 10 of the drive housing 7, the design of which will be explained in more detail below.

Besides the drive housing 7, the drive unit 2 also includes drive means 8, which are connected to the output slide 4 in at least one connection zone 24, for transmission of the drive forces generating the stroke movement 3. These drive means 8 are expediently accommodated at least partly in the interior of the drive housing 7. By way of example the drive means 8 include in each case at least one drive section 12, movable relative to the drive housing 7, which acts in the connection zone 24 on the output slide 4 and is in particular mounted on the latter. It is able to execute a driving motion 14, indicated by a double arrow, in the axial direction of the longitudinal axis 5. The driving motion of the drive section 12 may be generated by an external power input, for which purpose the drive means 8 are of a type which may be operated by electrical and/or fluid power.

The linear drive 1 of FIGS. 1 to 3 is equipped with drive means 8 of the type which is operable by fluid power. Here the drive means 8 contain in particular a fluid-actuated linear drive unit 15, which is preferably in the form of a fluid-actuated working cylinder, with a piston rod 12a as its drive section 12. The piston rod 12a is connected to a driving piston 12b, accommodated with linear movement facility in a cylinder tube 15a and designed for axial fluidic pressurisation in order to generate the driving motion 14. The piston rod 12a extends out from the drive housing 7 at a front end face 16, where it is mechanically connected in a connection zone 24 to a driving leg 18 of the output slide 4 extending in front of the front end face 16. In the drive housing 7 there run two control passages 22a, 22b, each leading into two drive chambers 15b, 15c separated from one another by the driving piston 12b and capable of being pressurised by a driving fluid, controlled in a harmonised manner, in order to drive the driving piston 12b and with it the piston rod 12a, and also the drive section 12 formed by the piston rod 12a.

The embodiment of FIG. 6 shows that the drive unit 2 may also be equipped with several and in particular with two linear drive units 15, functionally connected in parallel. Here the drive unit 2 contains in particular two working cylinders, operable by fluid power and in particular pneumatic, as linear drive units 15.

FIG. 4 illustrates by way of example drive means 8 of the electrically actuable kind, preferably involving electromechanical drive means 8. Here the drive section 12 consists of a flexible but tension-resistant drive train 12c, which may for example be a chain, but is preferably in the form of a toothed belt. This continuous annular drive train 12c runs round two guide wheels 23a, 23b, spaced apart in the axial direction of the longitudinal axis 5, of an electromechanical drive unit 23 of the drive means 8, and of which one is a rotationally driven guide wheel 23a, which may be driven to rotate by an electric motor 23c of the electromechanical drive unit 23 in order to generate a circulatory movement of the drive train 12c around the two guide wheels 23a, 23b in one or the other direction of circulation. In this circulatory movement, two train strands 12d, 12e extending parallel to one another between the two guide wheels 23a, 23b in the axial direction of the longitudinal axis 5 execute the linear driving motion 14 described above, with one of them (12d) being attached in a connection zone 24 to the output slide 4, in order to pull the latter, depending on the direction of the driving motion 14, in one or the other axial direction, thereby generating the stroke movement 3.

The illustrated and previously explained embodiments of drive means 8 are especially advantageous for implementation of the invention, but may alternatively also be of different design. For example, a non-contact connection by means of magnetic forces could be provided between the drive section 12 and the output slide 4. The drive means 8 could also for example be of the type of an electromechanical spindle drive, or of the type of an electrodynamic linear direct drive. This list should not be taken as conclusive.

The linear drive 1 may be so designed that the output slide 4, at least in a retracted starting position which is evident from FIGS. 1 and 3, extends along most of the length of the drive housing 7. During the stroke movement 3, the output slide 4 travels a greater or lesser distance beyond the front end face 16 of the drive housing 7. As an alternative to this, the output slide 4 may also be so designed that, irrespective of its momentary position, it always remains wholly within the axial length of the drive housing 7, so that the absolute length of the linear drive 1 does not vary during its operation.

Expediently the output slide 4 has one or more mounting interfaces 19, indicated only schematically in the drawing, to which moving external components or external components to be positioned may be fixed, for example machine parts or also a gripping device.

The main component of the drive housing 7 is the guide body 10, which has a single-piece structure and is made of metal, and in particular of steel. Specifically the guide body 10 is a sheet metal body, made of a metal sheet and in particular out of a steel sheet. A special advantage of this is that the single-piece guide body 10 is a bent sheet metal part, i.e. a body produced by bend forming from a previously prepared unworked sheet metal part 25, as indicated by dot-dash lines in FIGS. 3, 5 and 6.

The unworked sheet metal part 25 is formed by bending by one or more suitable bending tools into the desired end shape of the guide body 10, as indicated by various arrows 26. Before the bend forming process the unworked sheet metal part 25, preferably in the form of a flat sheet, is expediently suitably contoured at the edges and, for the purpose of this contouring, is in particular cut to size, in particular owing to variability by laser cutting, but also in principle by a stamping or other preparation process.

The guide body 10 has the longitudinal axis 5 referred to above, and a transverse axis 27 at right-angles to this longitudinal axis 5. The guide body 10 also has a vertical axis 28 at right-angles to the longitudinal axis 5 and the transverse axis 27. By means of the linear guidance means 6, the output slide 4 is supported immovably all-round relative to the guide body 10, in the plane spanned by the transverse axis 27 and the vertical axis 28. The output slide 4 has as its only scope for freedom of movement relative to the guide body 10 the axial direction of the longitudinal axis 5.

The guide body 10 has several bending areas 32 extending parallel to the longitudinal axis 5, in which leg sections 33 of the guide body 10, bent relative to one another, merge into one another. At these bending areas 32, the unworked sheet metal part 25 has been bent under plastic deformation in the manufacture of the guide body 10. The bending is made in particular in a plane at right-angles to the longitudinal axis 5.

The bending process is carried out in such a way that the guide body 10 thereby produced has two leg sections 33 lying opposite one another with clearance transversely to the longitudinal axis 5. On account of their function they may be described as guide legs 34. These guide legs 34 are the aforementioned components of the linear guidance means 6 formed by the guide body 10, since they each have at least one guide track 35 extending in the axial direction of the longitudinal axis 5 and on which the output slide 4 is guided with linear movement capability to execute the stroke movement 3. Since the guide track or tracks 35 provided on the one guide leg 34 is or are spaced apart from the further guide track or tracks 35 provided on the other guide leg 34 transversely to the longitudinal axis 5, the linear guidance means 6 are able to absorb tilting forces initiated in the output slide 4.

In all embodiments each guide leg 34 defines a single guide track 35, which may well however be comprised of several guide track sections with long-side clearance from one another. In embodiments not depicted, each guide leg 34 is equipped with several guide tracks 35 extending parallel to one another.

Expediently the guide tracks 35 are formed in such a way that guide tracks 35 provided on the two guide legs 34 lie opposite in pairs in the axial direction of the transverse axis 27. Preferably, therefore, at least one guide track 35 of the one respective guide leg 34 is placed with reference to the vertical axis 28 at the same height as one guide track 35 of the other respective guide leg 34.

Expediently, each of the guide tracks 35 is formed by a groove-like recess 36 of the relevant guide leg 34. This applies in the case of all embodiments. In particular, groove sides of these groove-like recesses 36 lying opposite one another with clearance form in each case one of the guide tracks 35.

The implementation of the guide tracks 35 in the form of groove-like recesses 36 has the advantage that the guide tracks 35 are able to cooperate in an optimal supporting manner with guide elements 37 of the linear guidance means 6, which engage with or dip into the relevant groove-like recess 36 with at least part of their cross-section. Preferably several guide elements 37 engage in each groove-like recess 36, all resting at one end on the assigned guide track 35 and at the other end on a mating guide track 38 formed on the output slide 4. Each mating guide track 38 is formed preferably by a longitudinal groove 42 defined by the output slide 4 and extending in the axial direction of the longitudinal axis 5, with this longitudinal groove 42 lying opposite a groove-like recess 36 of the guide body 10, so that a guide channel holding a multiplicity of guide elements 37 is formed. When the output slide 4 executes the stroke movement 3 this produces, depending on the design of the guide elements 37, a sliding or rolling along of the guide elements 37 on the guide track 35 and the mating guide track 38 lying opposite the former.

Although the linear guidance means 6 may also in principle provide sliding guidance, it is however advantageous to implement this in the form of roller guidance. In this connection, the guide elements 37 are in the form of roller elements, in particular spherical bodies as depicted. The guide elements 37 also belong to the linear guidance means 6.

The guide elements 37 in the form of roller elements may, if they are assigned to one and the same guide track 35, be combined by a cage element into a roller element assembly which, during the stroke movement 3 of the output slide 4, is moved as a unit along the guide track 35, with all roller elements rolling along the relevant guide track 35. In another preferred embodiment, the linear guidance means 6 are in the form of so-called recirculating ball bearings, wherein the roller elements assigned to a particular guide track 35 circulate during the linear movement of the output slide 4 in a circulation channel which is defined by guide units preferably in cassette form, mounted on a slide base body of the output slide 4.

The linear drive 1 of the embodiment may, because of the bend forming of the guide body 10, be manufactured especially inexpensively. Further cost reduction is possible when the output slide 4, at least insofar as it defines the mating guide track 38, has a single-piece slide body which is also a bent sheet metal part. In this way, the slide body of the output slide and the guide body 10 of the drive housing 7 may be manufactured using the same forming technology.

The groove-like recesses 36 defining the guide tracks 35 may be introduced into the assigned guide leg 34 by a stamping process, in particular prior to the bend forming of the unworked sheet metal part 25. In any event it is advantageous for the groove-like recesses 36 to be formed in the guide legs 34 by shaping without cutting. It is considered especially advantageous for the two guide legs 34, and this applies to all embodiments, to be bent directly in such a way that they have a cross-sectional contour forming the respectively assigned groove-like recess 36, meaning the cross-section defined in a plane spanned by the transverse axis 27 and the vertical axis 28. Otherwise expressed, the guide tracks 35 are formed in particular by bent structural sections 41 of the relevant guide leg 34, the profiling of which is created by the bend forming of the unworked sheet metal part 25.

Accordingly, in the embodiment, the guide legs 34 are bent into a trough-shaped structure to form the guide tracks 35 and the groove-like recesses 36 defining the guide tracks 35 respectively.

The embodiment of FIGS. 1 to 3 illustrates that the guide tracks 35 may be located on outer sides 43 of the two guide legs 34 facing away from one another. In this case, in the area of the guide leg 34, the guide body 10 is ridden over on the outside. One may say that the guide tracks 35 here define the inner tracks for the guide elements 37.

FIGS. 4 to 6 illustrate an especially advantageous alternative design, in which the guide tracks 35 are located on facing inner sides 44 of the guide legs 34. This makes possible an especially compact embodiment in which the output slide 4 reaches in between the guide legs 34. In this embodiment, the guide tracks 35 form as it were the outer tracks of the running tracks of the guide elements 37.

The guide body 10 is expediently so formed that each guide leg 34 is a single-piece component of a shaped guide body section 45 with a substantially L-shaped profile. For simplicity, the latter will be described hereafter as the L-shaped guide body section 45. This design applies to all embodiments. The transition zone between the two L-Iegs 45a, 45b of each L-shaped guide body section 45 is formed by one of the bending areas 32, wherein the one first L-leg 45a has a leg section 33 forming the guide leg 34. This first L-leg 45a may however also be so bent in at least one bending area 32 that it also contains a further leg section 33 of the guide body 10 apart from the guide leg 34.

The respective other second L-leg 45b of each L-shaped guide body section 45 is preferably oriented in the axial direction of the transverse axis 27. The first L-leg 45a, on the other hand, extends at least substantially in the vertical direction of the linear drive 1.

Preferably the L-shaped guide body sections 45 are so aligned that their second L-legs 45b face one another, and at the same time lie at the same height, relative to the axial direction of the vertical axis 28. In this connection it is especially advantageous if the two second L-Iegs 45b merge into one another and form a single-piece base leg 46 of a guide body section with a substantially U-shaped profile, which may be described below, for simplicity, as the U-shaped guide body section 47.

One and the same guide body 10 may therefore be so bent that it has not only two L-shaped guide body sections 45 but also a U-shaped guide body section 47, wherein expediently the U-shaped guide body section 47 simultaneously also forms the two L-shaped guide body sections 45.

In the U-shaped guide body section 47, the leg sections adjoining the base leg 46 on either side have the guide legs 34.

The guide body 10 may also be so profiled by the bending process that the two second L-legs 45b do not merge into one another directly in a straight line, but instead via a single-piece intermediate structure, connected to them and of any desired profile, wherein any such intermediate structure may be profiled, for example also at least partly curved or circular-arc-shaped or polygonal.

The guide body 10 is in particular so profiled, viewed in cross-section, that it defines a central internal space 48 extending directly between the two guide legs 34. In the embodiments, the central internal space 48 involves the inner area partly encompassed by the U-shaped guide body section 47.

The central internal space 48 is intended to accommodate at least partly the drive means 8. For this purpose, FIGS. 1 to 3 show a possible embodiment in which, amongst other things, the drive section 12 of the drive means 8 extends into the central internal space 48. In particular there is the option of accommodating a fluid-actuated linear drive unit 15 in the central internal space 48.

Expediently attached at the end and either side of the guide body 10 is an end body 52, 53, formed separately from the guide body 10. For better distinction they should be described as the front end body 52 and the rear end body 53 and form further components of the drive housing 7 additional to the guide body 10. Expediently the central internal space 48 is sealed at both ends by the respective sealing bodies 52, 53 positioned there.

The sealing bodies 52, 53 may for example be fixed to the guide body 10 by means of at least one tie rod 54, passing through the central internal space 48 in the axial direction and clamping them to the front and rear end faces of the guide body 10. By way of example, two tie rods 54 are provided for this purpose.

In a modified design of the linear drive 1, the central internal space 48 is closed by an end body at only one end, and is open at the other end.

The single-piece guide body 10 may also be so profiled by bending that it forms, in addition to a central internal space 48, at least one outer internal space 55 flanking the long side of the central internal space 48 and separated at least partly from the latter by at least one leg section 33 of the guide body 10. This leg section or sections 33 is or are designated below as the separating leg section 33a.

At least one separating leg section 33a is expediently formed with the cooperation of one of the guide legs 34. It is for example possible, in accordance with FIG. 6, for a guide leg 34 to form a separating leg section 33a which, as sole separating leg section 33a, separates the central internal space 48 from an outer internal space 55. Varying from this however there is also the option illustrated in FIG. 5, of attaching a further leg section 33 to the guide leg 34 forming the separating leg section 33a by means of a bending area 32, 32a defining a bending-back and forming a further separating leg section 33a, so that the central internal space 48 is separated from the adjacent outer internal space 55 by a double arrangement of separating leg sections 33a. The two separating leg sections 33a extend preferably in planes parallel to one another.

In order to define the outer internal space or spaces 55, the guide body 10 expediently has a section 57 with a box-shaped profile which is integrally joined to a guide leg 34.

FIGS. 5 and 6 make clear that the guide body 10, in an advantageous embodiment, may also have two outer internal spaces 55 which flank the central internal space 48 on long sides lying opposite one another in the axial direction of the transverse axis 27, and each of which may be realised in the same manner, as described above. Preferably the two outer internal spaces 55 are defined by identically shaped sections of the guide body 10. In particular both outer internal spaces 55 may be defined by identically profiled box-shaped sections 57 of the guide body 10.

The drive means 8 may be mounted at least partly in at least one and expediently in each outer internal space 55. FIG. 6 shows for this purpose a possible form of construction in which a fluid-actuated linear drive unit 15 is accommodated in each outer internal space 55. In the embodiment of FIGS. 4 and 5, the two outer internal spaces 55 are used to accommodate in each case one of the two train strands 12d, 12e of the drive train 12c, which extends in the outer internal space 55 concerned in the axial direction of the longitudinal axis 5.

It is of course possible to use only one of the outer internal spaces 55 to accommodate components of the drive means 8. It is also possible to use not only the central internal space 48 but also one or all of the outer internal spaces 55 for the accommodation of components of the drive means 8.

Sealing bodies 52, 53 mounted at the ends of the guide body 10 are preferably so designed as to close partly and preferably completely at the relevant end face all internal spaces 48, 55 which are defined by the guide body 10.

The guide body 10 has two edge sections 58 extending in the axial direction of the longitudinal axis 5. If the guide body 10 is viewed in cross-section, it has a continuous single-piece course between the two edge sections 58. These edge sections 58 are formed before bending of the unworked sheet metal part 25 by opposite longitudinally extending edge sections of the unworked sheet metal part 25.

The guide body 10 may now for example be so bent that the edge sections 58 are located on the guide legs 34, i.e. the guide legs 34 end on one side with in each case one of the edge sections 58. Over and above that, it is possible to bend the guide body 10 in such a way that the guide legs 34 are each located between two bending areas 32 and consequently also in each case between further leg sections 33, bent in this respect. In this connection there is according to FIGS. 5 and 6 the advantageous option to attach to one end of at least one guide leg 34 a box-shaped section 57, in order to form an outer internal space 55.

According to FIG. 5, the box-shaped section 57 may be so formed that a free ending edge section 58 of the guide body is arranged with clearance from the guide leg 34 in the vertical direction of the guide body 10, thus forming between the edge section 58 and the guide leg 34 an air gap 62 running in the axial direction of the longitudinal axis 5, and through which the output slide 4 may dip with an edge section of the box-shaped section 57.

FIG. 6 illustrates an embodiment in which the guide body 10 is so bent that the free edge sections 58 lie at the same height as the base leg 46 of the U-shaped guide body section 47. The edge section 58 is to be found in particular in the direct vicinity of a bending area 32 which connects the two L-legs 45a, 45b to one another. Here it is possible to weld the edge section 58 to the aforementioned bending area 32, to increase overall structural rigidity. The embodiment shown, however, is one in which the aforementioned components are not joined together.

All embodiments are distinguished by the fact that the diverse leg sections 33 have substantially a linear extent when viewed in cross-section at right-angles to the longitudinal axis 5. It should however be mentioned that the guide body 10 may also be so profiled that rounded sections are produced. In particular there is the option of making at least one section circular-arc-shaped, so that it may in particular be used directly to accommodate parts of the drive means 8, for example a circular-arc-shaped housing of a linear drive unit 15.

In a preferred embodiment, at least one bead 50 extending in the axial direction of the longitudinal axis 5 is formed in the guide body 10 by suitable bend forming, as indicated in FIG. 6 by dot-dash lines. By this means, the stiffness of the guide body 10 may be increased.

Expediently at least one outer surface section of the guide body 10 forms a lay-on surface 51 for laying the guide body 10 on a substrate and/or a support structure. In FIG. 3, such a lay-on surface 51 is indicated. The aforementioned bead 50 may in particular be so formed that it is flanked by two strip-shaped lay-on surfaces 51 extending in the axial direction of the longitudinal axis 5, as illustrated in FIG. 6.

1. A linear drive with a drive unit which has a drive housing with a longitudinal axis, also with an output slide which is guided on the drive housing in a linear movable manner to execute a stroke movement oriented in the axial direction of the longitudinal axis, and with drive means to generate the stroke movement of the output slide, wherein the drive housing has a single-piece guide body, on which are formed several guide tracks, extending in the axial direction of the longitudinal axis and spaced apart transversely to the longitudinal axis, and on which the output slide is linear movably guided to execute the stroke movement, and wherein the single-piece guide body is a bent sheet metal part with several leg sections which are bent relative to one another in bending areas extending parallel to the longitudinal axis, wherein at least two of these leg sections lie opposite to each other with clearance transversely to the longitudinal axis, each of them forming a guide leg which has at least one of the guide tracks.

2. A linear drive according to claim 1, wherein the guide tracks are formed by groove-like recesses of the guide legs.

3. A linear drive according to claim 1, wherein the guide tracks are formed by profiled bent structural sections of the guide legs.

4. A linear drive according to claim 3, wherein the guide legs are bent into a trough shape at the profiled bent structural sections to form the guide tracks.

5. A linear drive according to claim 1, wherein the guide tracks are located on the inner sides-which face one another or on the outer sides facing away from one another, of the guide legs.

6. A linear drive according to claim 1, wherein each guide leg is a single-piece component of a guide body section with a profile which is at least substantially L-shaped.

7. A linear drive according to claim 1, wherein each guide leg is a single-piece component of a guide body section with a profile which is at least substantially U-shaped.

8. A linear drive according to claim 1, wherein the guide body is made of a bent steel sheet component.

9. A linear drive according to claim 1 wherein at least one guide element supporting the output slide relative to the drive housing, transversely to the longitudinal axis, is in contact with each of the guide tracks (35) of the guide body and is in the form of a roller element, wherein several guide elements are in contact with each guide track at the same time.

10. A linear drive according to claim 1, wherein there is provided at one or both end faces of the guide body an end body of the drive housing which is separate from the guide body, wherein expediently at least one internal space passes axially through the guide body and is at least partly closed at the end by the end body provided at the relevant end face.

11. A linear drive according to claim 1, wherein the drive means are at least partly mounted in at least one internal space at least partly defined by the guide body.

12. A linear drive according to claim 1, wherein single-piece guide body is so bent that it defines a central internal space extending directly between the guide legs and in which the drive means are expediently at least partly mounted.

13. A linear drive according to claim 1, wherein the single-piece guide body is so bent that it defines a central internal space extending directly between the guide legs and in addition also defines at least one outer internal space flanking the long side of the central internal space and separated at least partly from the central internal space by at least one leg section of the guide body.

14. A linear drive according to claim 13, wherein the guide body defines two outer internal spaces (55) flanking the central internal space on opposite long sides.

15. A linear drive according to claim 14, wherein the drive means are at least partly mounted in the outer internal space or spaces of the guide body.

16. A linear drive according to claim 1, wherein the drive means are designed as electrical and/or fluid-actuated drive means.

17. A method for the manufacture of a linear drive including a drive unit which has a drive housing with a longitudinal axis, and is equipped with an output slide which is guided on the drive housing in a linearly movable manner to execute a stroke movement oriented in the axial direction of the longitudinal axis, and also with drive means to generate the stroke movement of the output slide, wherein the drive housing has a single-piece guide body, on which are formed several guide tracks, extending in the axial direction of the longitudinal axis and spaced apart transversely to the longitudinal axis, and on which the output slide is linear movably guided to execute the stroke movement, wherein the single-piece guide body is made by bend forming as a bent sheet metal part based on a plate-shaped unworked sheet metal part suitably contoured beforehand at the edges, wherein the unworked sheet metal part is bent, to form several leg sections of the guide body, at several bending areas extending parallel to the longitudinal axis in such a way that at least two of these leg sections lie opposite with clearance transversely to the longitudinal axis and are respectively forming a guide leg which is assigned at least one of the guide tracks.

18. A method according to claim 17, wherein to create the guide tracks, the two leg sections forming the guide legs are bent directly during the bend forming in such a way that they have a trough-shaped structure, with the trough-shaped structure being used as the guide track.
